(19) United States
(12) Patent Application Publication
(10) Pub. No.: US 2023/0321464 A1
(43) Pub. Date: Oct. 12, 2023

(54) BREATHING APPARATUS AND CHARGING SYSTEM

(71) Applicant: 3M INNOVATIVE PROPERTIES COMPANY, St. Paul, MN (US)

(72) Inventors: Michael L. Parham, Marine on St. Croix, MN (US); Douglas D. Jensen, Woodbury, MN (US); Kenneth J. Krepel, Plymouth, MN (US); Erik J. Hatinen, Monroe, NC (US); Kevin W. Eberman, St. Paul, MN (US); Steven T. Awiszus, Woodbury, MN (US); Dean J. Mitchell, Hilperton Marsh (GB); Chris Ellerby, Skelmersdale (GB)

(21) Appl. No.: 18/042,790

(22) PCT Filed: Aug. 27, 2021
(86) PCT No.: PCT/IB2021/057864

§ 371 Date: Feb. 24, 2023

Related U.S. Application Data
(60) Provisional application No. 63/074,527, filed on Sep. 4, 2020.

(51) Int. Cl. A62B 18/00

(52) U.S. Cl. CPC A62B 18/006

(57) ABSTRACT

A breathing apparatus includes a blower unit including a blower. The breathing apparatus further includes a battery pack including at least one electrochemical cell. The breathing apparatus further includes an adaptor including an adaptor housing physically connected to the blower unit and the battery pack. The adaptor further includes electrical contacts that engages with corresponding electrical terminals of the blower unit and the battery pack, such that the blower is electrically coupled to the electrochemical cell. The adaptor further includes at least one communication interface for receiving data from at least one of the blower unit and the battery pack, and transmitting data to an external device.

### TECHNICAL FIELD

The present disclosure relates to a breathing apparatus and a charging system for the breathing apparatus.

### BACKGROUND

Personal protective equipment (PPE), such as respiratory protection devices, may be used by emergency personnel, for example, firefighters, law enforcement, first responders, healthcare professionals, paramedics, or other personnel who work in potentially hazardous environments, for example, chemical environments, biological environments, nuclear environments, and fires. While a large variety of respiratory protection devices are available, some commonly used devices may include powered air purifying respirators (PAPR) and self-contained breathing apparatus (SCBA).

Conventional respiratory protection devices may generate various forms of data, such as battery state of charge, filter clogging, device status, alarm events, configuration data, date and time of usage, operational data, data such as gas flow rate, etc. However, such devices lack the ability to communicate such data with an external system. Conventional devices need to be kept out of service to access this data, such as during pre-set maintenance or service intervals. This may lead to increased unavailability of the device to an end user for its primary functions, and hence, lower usage. Further, the end users may need to invest in a device that includes connectivity features provided with the device.

### SUMMARY

In one aspect, a breathing apparatus is described. The breathing apparatus includes a blower unit including a blower. The blower unit further includes at least one blower electrical terminal electrically connected to the blower and at least one blower communication terminal communicably coupled to the blower. The breathing apparatus further includes a battery pack including at least one electrochemical cell. The battery pack further includes at least one battery electrical terminal electrically connected to the at least one electrochemical cell and at least one battery communication terminal communicably coupled to the at least one electrochemical cell. The breathing apparatus further includes an adaptor including an adaptor housing mechanically connected to the blower unit and the battery pack. The adaptor further includes at least one first electrical contact disposed on the adaptor housing and electrically connected with the at least one battery electrical terminal of the battery pack. The adaptor further includes at least one second electrical contact disposed on the adaptor housing and electrically connected with the at least one blower electrical terminal of the blower unit. The adaptor further includes at least one electrical connection disposed in the adaptor housing and electrically connecting the at least one first electrical contact and the at least one second electrical contact, such that the blower is electrically coupled to the at least one electrochemical cell. The adaptor further includes at least one communication interface associated with the adaptor housing and communicably coupled to the at least one blower communication terminal and the at least one battery communication terminal. The at least one communication interface is configured to exchange data with an external device.

In another aspect, a charging system is described. The charging system includes a battery pack including at least one electrochemical cell. The battery pack further includes at least one battery electrical terminal electrically connected to the at least one electrochemical cell and at least one battery communication terminal communicably coupled to the at least one electrochemical cell. The charging system further includes an adaptor including an adaptor housing mechanically connected to the battery pack. The adaptor further includes at least one first electrical contact disposed on the adaptor housing and electrically connected with the at least one battery electrical terminal of the battery pack. The adaptor further includes at least one electrical connection disposed in the adaptor housing and electrically coupled to the at least one first electrical contact. The adaptor further includes at least one communication interface associated with the adaptor housing and communicably coupled to the at least one battery communication terminal. The at least one communication interface configured to exchange data with the battery pack. The charging system further includes a charger communicably coupled to the at least one electrical connection of the adaptor. The charger includes at least one charger interface communicably coupled to the at least one communication interface of the adaptor. The at least one charger interface is configured to transmit data between the at least one communication interface and an external device.

In a further aspect, a breathing apparatus is described. The breathing apparatus includes a blower unit including a unit housing and a blower. The blower unit further includes at least one blower electrical terminal disposed on the unit housing and electrically connected to the blower. The blower unit further includes at least one blower communication terminal disposed on the unit housing and communicably coupled to the blower. The breathing apparatus further includes a battery pack for powering the blower unit. The battery pack includes a pack housing and at least one electrochemical cell disposed in the pack housing. The battery pack further includes at least one battery electrical terminal disposed on the pack housing and electrically connected to the at least one electrochemical cell. The battery pack further includes at least one battery communication terminal disposed on the pack housing and communicably coupled to the at least one electrochemical cell. The breathing apparatus further includes an adaptor including an adaptor housing physically and detachably connected to the unit housing and the pack housing. The adaptor further includes at least one first electrical contact disposed on the adaptor housing and electrically connected with the at least one battery electrical terminal of the battery pack. The adaptor further includes at least one second electrical contact disposed on the adaptor housing and electrically connected with the at least one blower electrical terminal of the blower unit. The adaptor further includes at least one electrical connection disposed in the adaptor housing and electrically connecting the at least one first electrical contact and the at least one second electrical contact, such that the blower is electrically coupled to the at least one electrochemical cell. The adaptor further includes at least one first communication contact disposed on the adaptor housing and engaged with the at least one battery communication terminal. The adaptor further includes at least one second communication contact disposed on the adaptor housing and engaged with the at least one blower communication terminal. The adaptor further includes at least one communication interface associated with the adaptor housing and communicably coupled to the at least one first communication contact and the at least one second communication contact. The at least one communication interface is configured to allow exchange of data between an external device and at least one of the blower unit and the battery pack.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 illustrates a schematic perspective view of an example of a breathing apparatus during use, in accordance with techniques of this disclosure.

FIG. 2 illustrates a detailed schematic perspective view of an example of a breathing apparatus, in accordance with techniques of this disclosure.

FIG. 3 illustrates an exploded front view of another example of the breathing apparatus of FIG. 2, in accordance with techniques of this disclosure.

FIG. 4 illustrates a schematic block diagram showing an example of a breathing apparatus, in accordance with techniques of this disclosure.

FIG. 5A illustrates a perspective bottom view of an example of an adaptor of the breathing apparatus, in accordance with techniques of this disclosure.

FIG. 5B illustrates a perspective top view of the adaptor of FIG. 5A, in accordance with techniques of this disclosure.

FIG. 6 illustrates a schematic block diagram of an example of a breathing apparatus, in accordance with techniques of this disclosure.

FIG. 7 illustrates a schematic block diagram of an example of the breathing apparatus during data transfer, in accordance with techniques of this disclosure.

FIG. 8. illustrates a schematic block diagram of a charging system, in accordance with techniques of this disclosure.

FIG. 9 illustrates a schematic block diagram of the charging system of FIG. 8 with data being transmitted between an adaptor and an external device, in accordance with techniques of this disclosure.

FIG. 10 is a flow chart illustrating a method for use with the breathing apparatus of FIG. 4, in accordance with techniques of this disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

According to aspects of this disclosure, a breathing apparatus includes a blower unit including a blower. The blower unit further includes at least one blower electrical terminal electrically connected to the blower and at least one blower communication terminal communicably coupled to the blower. The breathing apparatus further includes a battery pack having at least one electrochemical cell. The battery pack further includes at least one battery electrical terminal electrically connected to the at least one electrochemical cell and at least one battery communication terminal communicably coupled to the at least one electrochemical cell. The breathing apparatus further includes an adaptor including an adaptor housing mechanically connected to the blower unit and the battery pack. The adaptor further includes at least one first electrical contact disposed on the adaptor housing and electrically connected with the at least one battery electrical terminal of the battery pack. The adaptor further includes at least one second electrical contact disposed on the adaptor housing and electrically connected with the at least one blower electrical terminal of the blower unit. The adaptor further includes at least one electrical connection disposed in the adaptor housing and electrically connecting the at least one first electrical contact and the at least one second electrical contact, such that the blower is electrically coupled to the at least one electrochemical cell. The adaptor further includes at least one communication interface associated with the adaptor housing and communicably coupled to the at least one blower communication terminal and the at least one battery communication terminal. The at least one communication interface is configured to exchange data with an external device.

The adaptor may allow data to be transmitted to the external device through the at least one communication interface. The at least one communication interface is configured to engage data with the at least one battery communication terminal and the at least one blower communication terminal. In some cases, the blower unit and/or the battery pack may lack data communication capability due to absence of any communication interface. The adaptor including the at least one communication interface may be retrofitted with the blower unit and the battery pack in order to enable data transfer to and from the blower unit and/or the battery pack. This may allow data communication between the breathing apparatus and the external device in real-time while the breathing apparatus is operational. Therefore, the adaptor may allow intelligent monitoring and control of the breathing apparatus even in cases where the blower unit and the battery pack may lack data communication functionality.

Further, the at least one first electrical contact and the at least one second electrical contact may be configured to engage with the at least one battery electrical terminal and the at least one blower electrical terminal, respectively. Such a configuration of the adaptor may allow supply of electrical power from the at least one electrochemical cell to the blower unit through the at least one electrical connection disposed in the adaptor housing. The adaptor may enable smart or intelligent control of electrical power that is supplied to the blower unit as opposed to conventional devices which include a direct electrical connection between a blower and a battery.

In some examples, the adaptor may be selectively coupled to the breathing apparatus when required. Further, the adaptor may be coupled to the breathing apparatus as an aftermarket enhancement facilitating data communication between the breathing apparatus and the external device.

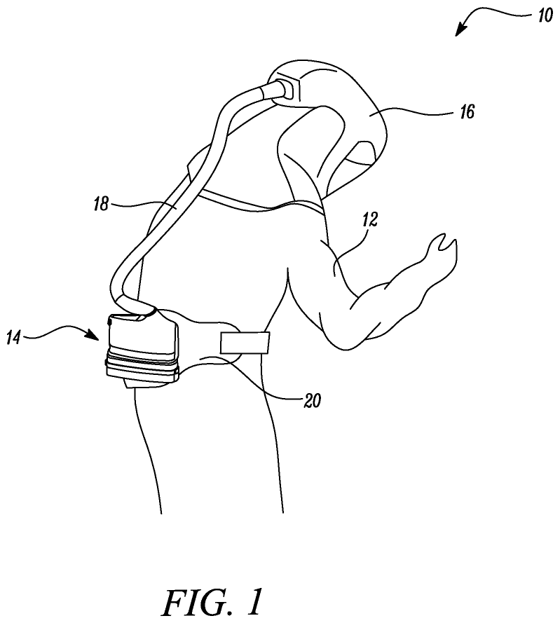

FIG. 1 illustrates a schematic view of an example of a breathing apparatus 10. The breathing apparatus 10 is intended to be worn by a user 12. In some examples, the breathing apparatus 10 may be used by emergency personnel, for example, firefighters, law enforcement, medical personnel, first responders, health professionals, paramedics, or other personnel who work in potentially hazardous environments, for example, chemical, biological or nuclear environments, fires, or other physical environments (such as, construction sites, agricultural sites, mining or manufacturing sites).

In some examples, the breathing apparatus 10 may be a part of a personal protective equipment (PPE). In some examples, the PPE may include respiratory protection equipment (including disposable respirators, reusable respirators, powered air purifying respirators, supplied air respirators, self-contained breathing apparatus). Other examples of PPE may include, but are not limited to, protective eyewear, such as visors, goggles, filters or shields (any of which may include augmented reality functionality), protective headwear, such as hard hats, hoods or helmets, hearing protection (including ear plugs and ear muffs), protective shoes, protective gloves, other protective clothing, such as coveralls and aprons, protective articles, such as sensors, safety tools, detectors, global positioning devices, mining cap lamps, fall protection harnesses, exoskeletons, self-retracting lifelines, heating and cooling systems, gas detectors, and any other suitable gear configured to protect the user 12 from injury.

The breathing apparatus 10 includes a blower unit 14 and a headtop 16. A flexible connection hose 18 connects the blower unit 14 and the headtop 16 in a fluid communicating manner. The headtop 16 may be configured to be worn on a head of the user 12. The blower unit 14 may be arranged on a harness 20, for example, a belt system, such that the user 12 may carry the blower unit 14 in any working environment.

In some examples, the blower unit 14 may include a blower (not shown) in which a fan wheel is arranged for producing a forced air flow. In some examples, the fan wheel may be driven by a prime mover, such as an electric motor. In some examples, one or more filters may be arranged upstream or downstream the fan wheel to filter ambient air suctioned by the fan wheel. For example, the blower unit 14 may draw the air through the blower and supply purified air to the headtop 16. In some examples, the filter may be configured to remove particles, gases, vapors, etc., from the ambient air before the air is delivered to the headtop 16. In some examples, one or more filters of different type and configuration may be utilized with the breathing apparatus 10. It should be understood that the breathing apparatus 10 as illustrated in FIG. 1 is shown by way of example only, and the type and configuration of the breathing apparatus 10 may differ based on application requirements. For example, the breathing apparatus 10 may not include the flexible connection hose 18 in certain instances, such as, for example, where the breathing apparatus 10 is a head or face mounted powered air purifying respirator (PAPR).

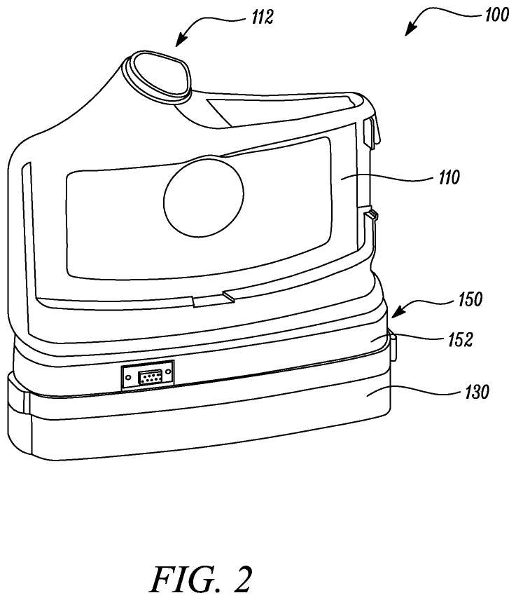

FIG. 2 illustrates a schematic perspective view of an example of a breathing apparatus 100. The breathing apparatus 100 may be used in a similar manner as the breathing apparatus 10 of FIG. 1. Some components of the breathing apparatus 100 are not shown for the purpose of illustration. The breathing apparatus 100 includes a blower unit 110 having a blower (not shown). In some examples, the blower unit 110 may be similar to the blower unit 14 of FIG. 1. In some examples, the blower of the blower unit 110 may include a housing in which a fan wheel is arranged for producing a forced air flow. The blower unit 110 further includes an opening 112 that is connected to a flexible hose (e.g., the flexible connection hose 18 of FIG. 1). The breathing apparatus 100 further includes a battery pack 130 having at least one electrochemical cell (not shown). In some examples, the battery pack 130 may be used to provide power the blower unit 110. The breathing apparatus 100 further includes an adaptor 150. The adaptor 150 includes an adaptor housing 152 physically connected to the blower unit 110 and the battery pack 130.

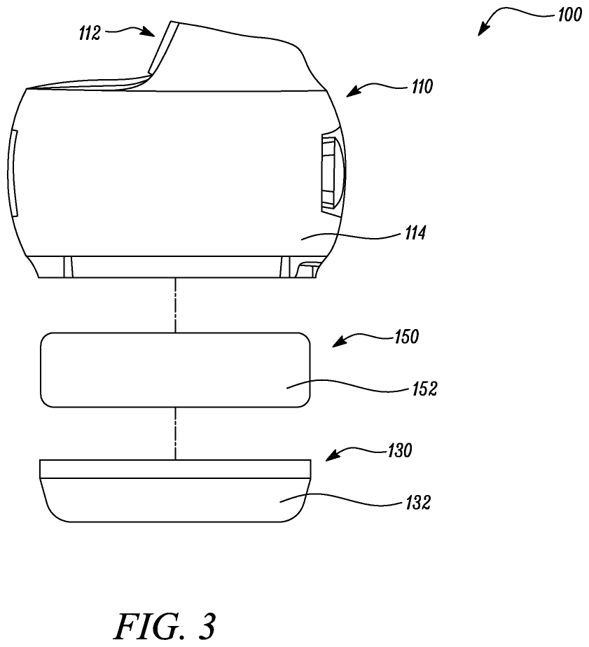

FIG. 3 illustrates an exploded front view of another example of the breathing apparatus 100 of FIG. 2. In the illustrated embodiment of FIG. 3, the breathing apparatus 100 includes the adaptor 150 positioned between the blower unit 110 and the battery pack 130. The blower unit 110 further includes a unit housing 114. The unit housing 114 may enclose various components of the blower unit 110, for example, the blower. The battery pack 130 further includes a pack housing 132. The pack housing 132 may enclose various components of the battery pack 130, for example, the at least one electrochemical cell. In some examples, the adaptor housing 152 of the adaptor 150 may be detachably connected to the blower unit 110 and/or the battery pack 130. Specifically, the adaptor housing 152 may be detachably connected to the unit housing 114 of the blower unit 110 and/or the pack housing 132 of the battery pack 130. In some cases, the adaptor housing 152 may be detachably connected to the unit housing 114 of the blower unit 110 via one or more snap-fit tabs (not shown). In such cases, the physical connections between the adaptor housing 152 and the unit and pack housings 114, 132 may include any suitable detachable connection. In some examples, the adaptor housing 152 of the adaptor 150 may be permanently attached to either or both of the unit housing 114 and the pack housing 132. The permanent connection(s) may include welding, adhesives, brazing, mechanical fasteners (e.g., rivets), and so forth. It is to be understood that the arrangement shown in FIG. 3 is exemplary in nature and the adaptor 150 may be arranged in any combination with the blower unit 110 and the battery pack 130.

As used herein, the term “detachably connected” means that a first component (e.g., the adaptor housing 152) may be readily separable from a second component (e.g., the unit housing 114 or the pack housing 132) without destroying or damaging either of the first and second components. The components are readily separable when the two components may be separated from each other without undue effort or a significant amount of time spent in separating the two components. For example, the components may be coupled to one another using fasteners, such as screws, latches, buckles, and the like, where a technician may uncouple the two components using a tool or the technician's hands. In addition, detachably connected components may be coupled without a fastener, such as by using a connector or by forming an interference or snap fit with respect to each other. It is to be understood that a combination of different methods may be used to removably couple the components.

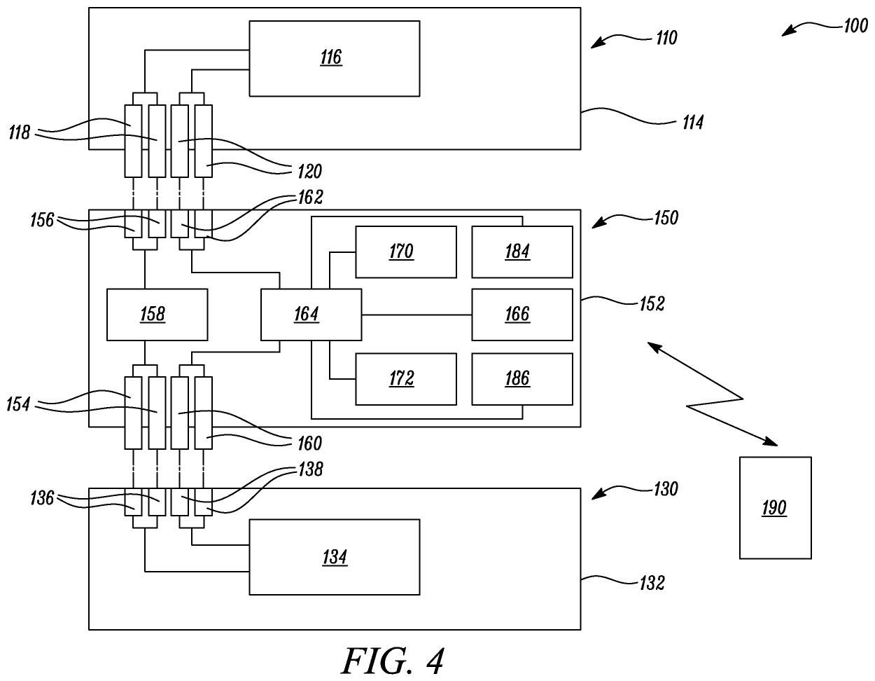

FIG. 4 illustrates a schematic block diagram of an example of the breathing apparatus 100. The breathing apparatus 100 includes the blower unit 110. The blower unit 110 includes a blower 116 disposed in the unit housing 114 of the blower unit 110. The blower unit 110 further includes at least one blower electrical terminal 118 electrically connected to the blower 116 and at least one blower communication terminal 120 communicably coupled to the blower 116. In some examples, the blower unit 110 may receive electrical power through the at least one blower electrical terminal 118. In some examples, the blower unit 110 may transmit or receive data through the at least one blower communication terminal 120. For example, the blower 116 may transmit or receive data through the at least one blower communication terminal 120. Further, the blower communication terminal 120 may exchange data wirelessly or through an electrical/physical contact. In some examples, the at least one blower electrical terminal 118 and the at least one blower communication terminal 120 may be disposed on the unit housing 114 of the blower unit 110. In the example of FIG. 4, the blower unit 110 includes a pair of blower electrical terminals 118 and a pair of blower communication terminals 120. However, the blower unit 110 may include any number and combination of blower electrical terminals 118 and blower communication terminals 120 based on application requirements.

The battery pack 130 includes at least one electrochemical cell 134. The at least one electrochemical cell 134 is arranged in the pack housing 132 of the battery pack 130. Generally, the at least one electrochemical cell 134 may be any type of electrochemical cell known in the art, including, but not limited to, rechargeable cells, fuel cells and electrolyzer cells. In some examples, the at least one electrochemical cell 134 may include both non-aqueous as well as aqueous electrochemical cells. An example of a non-aqueous electrochemical cell may be a lithium-ion battery cell. Aqueous electrochemical cells may be either acidic or alkaline. In the illustrated example, one electrochemical cell 134 is shown. However, the battery pack 130 may include any number of the electrochemical cells 134 arranged in series and/or parallel.

The battery pack 130 further includes at least one battery electrical terminal 136 electrically connected to the at least one electrochemical cell 134 and at least one battery communication terminal 138 communicably coupled to the at least one electrochemical cell 134. In some examples, the battery pack 130 may provide electrical power from the at least one electrochemical cell 134 through the at least one battery electrical terminal 136. In some examples, the battery pack 130 may transmit or receive data through the at least one battery communication terminal 138. For example, the battery pack 130 may transmit or receive data through the at least one battery communication terminal 138. Further, the battery communication terminal 138 may exchange data wirelessly or through electrical/physical contact.

In some cases, the at least one battery electrical terminal 136 and the at least one battery communication terminal 138 may be disposed on the pack housing 132. In the example of FIG. 4, the battery pack 130 includes a pair of battery electrical terminals 136 and a pair of battery communication terminals 138. However, the battery pack 130 may include any number and combination of battery electrical terminals 136 and battery communication terminals 138 based on application requirements. In some examples, the at least one electrochemical cell 134 may be rechargeable. In some examples, the at least one electrochemical cell 134 of the battery pack 130 may be arranged replaceably or removably in the pack housing 132, such that the at least one electrochemical cell 134 may be charged outside the battery pack 130 or may be exchanged with a new one.

The adaptor 150 of the breathing apparatus 100 includes an adaptor housing 152 mechanically connected to the blower unit 110 and the battery pack 130. The adaptor 150 further includes at least one first electrical contact 154 disposed on the adaptor housing 152 and electrically connected with the at least one battery electrical terminal 136 of the battery pack 130. In some examples, the at least one first electrical contact 154 and the at least one battery electrical terminal 136 may be physically coupled or engaged to each other when the adaptor housing 152 is detachably or permanently coupled to the pack housing 132.

The adaptor 150 further includes at least one second electrical contact 156 disposed on the adaptor housing 152 and electrically connected with the at least one blower electrical terminal 118 of the blower unit 110. In some examples, the at least one second electrical contact 156 and the at least one blower electrical terminal 118 may be physically coupled or engaged to each other when the adaptor housing 152 is detachably or permanently coupled to the unit housing 114. In the example of FIG. 4, the adaptor 150 includes a pair of first electrical contacts 154 and a pair of second electrical contacts 156 corresponding to the pair of battery electrical terminals 136 and the pair of blower electrical terminals 118, respectively. However, the adaptor 150 may include any number and combination of first electrical contacts 154 and second electrical contacts 156 based on application requirements.

The adaptor 150 further includes at least one electrical connection 158 disposed in the adaptor housing 152 and electrically connecting the at least one first electrical contact 154 and the at least one second electrical contact 156, such that the blower 116 of the blower unit 110 is electrically coupled to the at least one electrochemical cell 134. As such, an electrical connection may be established between the battery pack 130, the adaptor 150 and the blower unit 110 through the at least one battery electrical terminal 136, the at least one first electrical contact 154, the at least one electrical connection 158, the at least one second electrical contact 156, and the at least one blower electrical terminal 118. In some examples, the at least one electrochemical cell 134 provides electrical power to the blower 116 of the blower unit 110 through the electrical connection established between the battery pack 130 and the blower unit 110.

In some examples, the at least one electrical connection 158 may include one or more electrical conductors that facilitate transfer of electrical power. Further, the at least one electrical connection 158 may include one or more printed circuit boards (PCB) having electrically conductive traces formed on one or more surfaces to facilitate transfer of electrical power. In some examples, the blower 116 of the blower unit 110 may include a prime mover (e.g., an electric motor) for driving a fan wheel. The prime mover may be driven by the electrical power received from the at least one electrochemical cell 134 and the battery pack 130.

The adaptor 150 may further include at least one first communication contact 160 disposed on the adaptor housing 152 and engaged with the at least one battery communication terminal 138. In some examples, the at least one first communication contact 160 and the at least one battery communication terminal 138 may be physically coupled or engaged to each other when the adaptor housing 152 is detachably or permanently coupled to the pack housing 132. The adaptor 150 may further include at least one second communication contact 162 disposed on the adaptor housing 152 and engaged with the at least one blower communication terminal 120. In some examples, the at least one second communication contact 162 and the at least one blower communication terminal 120 may be physically coupled or engaged to each other when the adaptor housing 152 is detachably or permanently coupled to the unit housing 114. In the example of FIG. 4, the adaptor 150 includes a pair of first communication contacts 160 and a pair of second communication contacts 162. However, the adaptor 150 may include any number and combination of first communication contacts 160 and second communication contacts 162 based on application requirements.

The adaptor 150 further includes at least one communication interface 164 associated with the adaptor housing 152 and communicably coupled to the at least one blower communication terminal 120 and the at least one battery communication terminal 138. The at least one communication interface 164 is configured to exchange data with an external device 190. Specifically, the at least one communication interface 164 is communicably coupled to the at least one first communication contact 160 and the at least one second communication contact 162.

A data communication path may be established between the blower unit 110, the adaptor 150 and the battery pack 130 through the at least one battery communication terminal 138, the at least one first communication contact 160, the at least one communication interface 164, the at least one second communication contact 162, and the at least one blower communication terminal 120. For example, the at least one communication interface 164 may exchange data with at least one of the blower unit 110 and the battery pack 130. Further, the data communication may occur between the at least one blower communication terminal 120 and the at least one battery communication terminal 138 through direct electrical/physical contact. In some examples, the at least one communication interface 164 may be wirelessly coupled to the at least one battery communication terminal 138 and the at least one blower communication terminal 120. The at least one communication interface 164 may also facilitate data communication between the blower unit 110, the adaptor 150 and the battery pack 130.

In some examples, the external device 190 may be a computer system, a server, or a portable user interface device. In some examples, the computer system or the server may be in the form of a general-purpose computing device. The components of the computer system or the server may include one or more processors or processing units, a system memory, and a bus that couples various system components including the system memory to the processor. System memory may include computer system readable media in the form of volatile memory, such as random access memory (RAM) and/or cache memory. The computer system or the server may further include other removable/non-removable, volatile/non-volatile computer system storage media. By way of example only, a storage system may be provided for reading from and writing to a non-removable, non-volatile magnetic media.

In some examples, the portable user interface device may be configured to execute an application (or app) that is tailored to provide an easy setup and/or easy to use interface for interaction with the breathing apparatus 100. In some cases, the external device 190 may be a smartphone or other mobile terminal, or a laptop, or any other portable computing/communication device. As such, the portable user interface device may include processing circuitry that is enabled to interface with the at least one communication interface 164 to program, control or otherwise interact with the breathing apparatus 100 in a manner described further in greater detail below. For example, the external device 190 may change device specific settings of the breathing apparatus 100.

In some examples, the adaptor 150 may further include a memory 170 disposed within the adaptor housing 152 and communicably coupled to the at least one communication interface 164. The memory 170 may be configured to store data received from the at least one communication interface 164. The memory 170 may be a main memory, a static memory, or a dynamic memory. The memory 170 may include, but may not limited to, computer readable storage media, such as various types of volatile and non-volatile storage media, including, but not limited to, random access memory, read-only memory, programmable read-only memory, electrically programmable read-only memory, electrically erasable read-only memory, flash memory, magnetic tape or disk, optical media and the like.

In some examples, the adaptor 150 may further include a processor 172 disposed within the adaptor housing 152 and communicably coupled to the at least one communication interface 164. The processor 172 may be configured to exchange data with the at least one communication interface 164. For example, the processor 172 may take part in bidirectional communication with the at least one communication interface 164. In some examples, the processor 172 may be further configured to process data received from the at least one communication interface 164. For example, the data may be related to device specific parameters of the breathing apparatus 100. In some examples, the device specific parameters may be processed by the external device 190.

In some examples, the processor 172 may be embodied in a number of different ways. For example, the processor 172 may be embodied as various processing means, such as one or more of a microprocessor or other processing elements, a coprocessor, or various other computing or processing devices including integrated circuits such as, for example, an ASIC (application specific integrated circuit), an FPGA (field programmable gate array), or the like. In some examples, the processor 172 may be configured to execute instructions stored in a memory (e.g., the memory 170) or otherwise accessible to the processor 172.

As such, whether configured by hardware or by a combination of hardware and software, the processor 172 may represent an entity (e.g., physically embodied in circuitry—in the form of processing circuitry) capable of performing operations according to some embodiments while configured accordingly. Thus, for example, when the processor 172 is embodied as an ASIC, FPGA, or the like, the processor 172 may have specifically configured hardware for conducting the operations described herein. Alternatively, as another example, when the processor 172 is embodied as an executor of software instructions, the instructions may specifically configure the processor 172 to perform the operations described herein. In some examples, the memory 170 may include a cache or random access memory for the processor 172. Alternatively, or in addition, the memory 170 may be separate from the processor 172, such as a cache memory of a processor, the system memory, or other memory.

The memory 170 may be operable to store instructions executable by the processor 172. The functions, acts or tasks illustrated in the figures or described herein may be performed by the processor 172 executing the instructions stored in the memory 170. The functions, acts or tasks may be independent of the particular type of instructions set, storage media, processor or processing strategy and may be performed by a software, a hardware, an integrated circuits, a firm-ware, a micro-code and the like, operating alone or in combination. Likewise, processing strategies may include multiprocessing, multitasking, parallel processing, and the like.

In some examples, the processor 172 may create, read, update, and delete data stored within the memory 170 via the at least one communication interface 164. In some examples, data may be associated with a user, such as a user identification number. In some examples, the data may include information such as, but not limited to, PPE identification, and data indicative of one or more sensed parameters. In some examples, data may be associated with various sensors provided with the breathing apparatus 100, such as a headtop position sensor that determines a position of a visor and frequency of opening/closing of the visor, a head detection sensor, a temperature sensor, etc.

In some examples, the processor 172 may further be configured to receive data from the battery pack 130 through the at least one communication interface 164. In some examples, data may be associated with parameters, such as remaining battery life at any given point in time, current drawn, charge cycle, temperature of the at least one electrochemical cell 134, battery pack usage time, batter pack usage cycle, etc. In some examples, the processor 172 may further be configured to transmit the data received from the battery pack 130 to the external device 190 through the at least one communication interface 164.

In some examples, the processor 172 may further be configured to receive data from the blower unit 110 through the at least one communication interface 164. For example, the processor 172 may determine amount of air being forced through the filter, and therefore, estimate a remaining filter life. In some examples, the processor 172 may track information, such as gas flow rate, temperature of components, pressure drop across the filter, filter presence/identification on filter, blower run time, filter usage time, filter usage cycle, and/or other parameters, such as whether the headtop 16 (shown in FIG. 1) is a loose or tight fitting head top. In some examples, the data received from the blower unit 110 may correspond to a type of filter associated the blower unit 110. In some examples, the processor 172 may further be configured to transmit the data received from the blower unit 110 to the external device 190 through the at least one communication interface 164.

In some examples, the processor 172 may further be configured to calibrate one or more flow settings of the blower unit 110 through the at least one communication interface 164. Flow settings may include various blower speeds of the blower 116 corresponding to various air flow settings, such as low, medium, high, etc. In some cases, the blower unit 110 may be provided with default flow settings from a manufacturer. Such default flow settings may require calibration before use. In other words, the blower speeds corresponding to the flow settings may need to be calibrated. However, the blower unit 110 may not include any provisions to directly modify or program such flow settings. The flow characteristics of the blower 116 may need to be calibrated based on external or internal factors, such that the blower 116 may provide optimal air flow for operation of the breathing apparatus 100. In some examples, the internal factors may include pressure drop across various components that changes as the system components are varied or changed. In such cases, the cumulative pressure drop may need to be considered for calibration of the flow settings of the blower 116. Other internal factors may include a type of filter and change in system components over time, such as filter clogging, etc. In some examples, the flow settings may be stored on the memory 170 that may be accessible to the processor 172.

In some examples, the external factors may include atmospheric pressure, air density, etc. In some examples, the adaptor 150 may further include at least one pressure sensor 184 for determining atmospheric pressure. In some examples, the processor 172 may be communicably coupled to the at least one pressure sensor 184 associated with the adaptor 150 through the at least one communication interface 164. In some example, the pressure sensor 184 may be configured to generate a pressure signal indicative of atmospheric pressure.

In some examples, the processor 172 may further be configured to receive the pressure signal from the pressure sensor 184 through the at least one communication interface 164 and compute one or more flow settings of the blower unit 110 based on the received pressure signal. For example, the processor 172 may compute the one or more flow settings based on predetermined data stored on the memory 170. In some examples, the one or more flow settings may compensate for changes in atmospheric pressure and/or air density. In some examples, the processor 172 may further be configured to transmit the one or more flow settings to the blower unit 110 through the at least one communication interface 164.

In some examples, the adaptor 150 or the processor 172 may control one or more operational settings of the breathing apparatus 100. The one or more operational settings may include blower speed, electric power supplied to the blower 116, motor current/voltage, On/Off state of the blower unit 110, battery parameters, etc. For example, the adaptor 150 may control or regulate power from the battery pack 130 to the blower unit 110. Further, the adaptor 150 may enable or disable power supply to the blower unit 110. For example, the adaptor 150 may stop power supply to the blower unit 110 in case of any technical issues with the blower unit 110, such as short circuit, motor damage, etc. In some examples, the adaptor 150 may restrict power supply to the blower unit 110 during maintenance, repair or troubleshooting. In some examples, the adaptor 150 may modify flow settings of the blower unit 110 that may not be initially available to the blower unit 110.

In some examples, the at least one communication interface 164 may include a wireless interface for transmitting data to the external device 190. Data and device specific parameters of the breathing apparatus 100 may be transmitted to the external device 190. In some examples, the device specific parameters may be related to the operation of the breathing apparatus 100. In some examples, the data may be associated with device configuration and unique identification designation (UID) of the breathing apparatus 100, the filter, or the headtop 16. In some examples, the data may be associated with device specific parameters (e.g., flow rate, volumetric flow, filter clogging, battery pack power), usage details including date and time, total runtime of the blower unit 110, run time of the blower unit 110 relative to a corresponding type of filter, alarm events associated with the breathing apparatus 100, such as low flow rate or low battery power, a charge cycle of the battery pack 130, remaining power of the battery pack 130, residual life of the battery pack 130, battery pack failure, electric motor control parameters, such as speed, current, voltage, and/or the like.

In some examples, the wireless interface associated with the at least one communication interface 164 may communicate data via one or more wireless communication protocols, such as Bluetooth®, infrared, Wi-Fi, Zigbee, wireless universal serial bus (USB), radio frequency, near-field communication (NFC), RFID protocols, or generally any wireless communication protocol. In some examples, data may be transmitted through a communication network. In some examples, the communication network may include one or more of a wireless network, a wired network, a local area network (LAN), a metropolitan area network (MAN), a wide area network (WAN), a wireless personal area network (WPAN), 802.11, 802.16, 802.20, WiMax networks, a direct connection such as through a Universal Serial Bus (USB) port, and the like, and may include a set of interconnected networks that make up the Internet. In some examples, the wireless network may include, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc. In some examples, the communication network may include a circuit-switched voice network, a packet-switched data network, or any other network capable for carrying electronic communication. For example, the communication network may include networks based on the Internet protocol (IP) or asynchronous transfer mode (ATM), etc.

Examples of the communication network may further include, but are not limited to, a personal area network (PAN), a storage area network (SAN), a home area network (HAN), a campus area network (CAN), an enterprise private network (EPN), Internet, a global area network (GAN), and so forth. Examples are intended to include or otherwise cover any type of network, including known, related art, and/or later developed technologies to connect the at least one communication interface 164 and the external device 190.

In some examples, the data and device specific parameters of the breathing apparatus 100 may be transmitted automatically. In some examples, the data and device specific parameters may be transmitted periodically to the external device 190. In some examples, data transmission may occur intermittently or continuously over a period of time. In some examples, the data may be transmitted when the breathing apparatus 100 is switched on after storage or a period of non-operation. This allows incorrect configuration of the breathing apparatus 100 to be detected. A corresponding adaptation may be made by the external device 190. In some examples, continuous checking of the device specific parameters and settings of the breathing apparatus 100 for up-to-date status and correctness may be performed by the external device 190. In some examples, the external device 190 may determine correct usage of the breathing apparatus 100 through the device specific parameters. In some examples, the external device 190 may exchange diagnostic and troubleshooting information with the breathing apparatus 100 through the at least one communication interface 164.

In some examples, the external device 190 may be used to determine useful life of the components of the breathing apparatus 100. Further, the components may be replaced based on determined device specific parameters. In some examples, the external device 190 may be utilized for statistical analysis of the data received from the breathing apparatus 100. In some examples, the external device 190 may determine if the battery pack 130 needs to be recharged based on power levels of the at least one electrochemical cell 134.

Similarly, data may be received by the breathing apparatus 100 from the external device 190 through the wireless interface. In some examples, the data received by the breathing apparatus 100 may be configured to be stored in the memory 170 through the at least one communication interface 164. In some examples, data and device specific parameters related to the breathing apparatus 100, especially software updates, may be transmitted through the wireless interface. Furthermore, the external device 190 may be used to determine whether the parameters associated with the breathing apparatus 100, especially the program software, are up to date. Additionally, the external device 190 may allow reconfiguration and modification of device specific parameters and settings of the breathing apparatus 100 through the adaptor 150. In some example, the external device 190 may be used to switch a power status of the breathing apparatus 100. In some example, the external device 190 may be used to adjust a volumetric flow rate of the blower unit 110 based on a breathing rate of a user.

The at least one communication interface 164 of the blower unit 110 may also be configured to receive software updates for the processor 172. In some examples, a software update may be sent through the external device 190 to the processor 172 for a newly connected component, for example, a newly connected filter or a headtop, such that the breathing apparatus 100 may be adapted to the newly connected components in a flexible manner.

In some examples, the external device 190 may receive data from a group of breathing apparatus 100. For example, the external device 190 may determine a power level of the one or more breathing apparatus 100 from the group of breathing apparatus 100. In some examples, the external device 190 may receive a unique identification designation (UID) associated with the breathing apparatus 100, for example, filter UID, headtop UID, blower UID, or apparatus UID. Such information may be useful in managing a fleet of breathing apparatus 100. It is to be understood that one or more type of data and device specific parameters mentioned above may be communicated to the external device 190 from the fleet of breathing apparatus 100.

In some examples, the external device 190 may calculate usage parameters, such as, but not limited to, usage time, breathing rate, breathing volume, breathing exertion, fatigue levels, distressed levels, alerts for servicing or failure issues, alerts and reminders for filter changes, type of filter, breathing apparatus performance, alerts for breathing apparatus 100 operating outside recommended range, alarm events, such as low flow rate and low battery pack power, amount of hazards filtered by use or per hour or over a period of time, pressure, temperature, battery pack load and battery pack use, battery pack condition/life, filter load, filter resistance, filter performance, prime mover performance and failure, use and compliance over time per user, filter recommendations based on load over time, breathing patterns, prediction of breathing pathologies or acute breathing changes, change in breathing pattern over time, and the like. In some examples, one or more parameters described above may be stored within the memory 170, for example, last filter load, type of filter, etc. In some examples, usage parameters may be calculated by the processor 172 of the adaptor 150 through the at least one communication interface 164. The processor 172 may retrieve device specific parameters directly from at least one of the blower unit 110 and the battery pack 130.

In some examples, the processor 172 or the external device 190 may obtain a current drawn from the battery pack 130 to determine a power On/Off status of the breathing apparatus 100. Additionally, the processor 172 or the external device 190 may determine a type of filter or headtop based on current drawn over time from the battery pack 130. Type of filter or headtop may be identified based on resistance offered by the filter and/or the headtop. Further, the processor 172 or the external device 190 may determine a filter clogging condition by monitoring current drawn from the battery pack 130. In general, a filter removes hazardous matter or gases from the ambient air suctioned by the blower unit 110 and may get clogged over time. In such a condition, the blower unit 110 may need additional power to force air through the clogged filter.

In some examples, the adaptor 150 may identify a type of filter associated with the breathing apparatus 100. For example, the adaptor 150 may read an RFID tag associated with the filter to determine the type of filter. Further, the adaptor 150 may modify the device specific parameters based on the type of filter. For example, flow rate of the blower unit 110 may be adjusted based on the type of filter. In some examples, the filter identification information may be transmitted to the external device 190. Further, the external device 190 or the adaptor 150 may update a software of the breathing apparatus 100 based on the filter identification information. For example, a filter may be added to the blower unit 110 that may offer higher pressure drop than existing filters. Such a type of filter may be identified by the adaptor 150 which may then control the device specific parameters based on the type of filter. Correspondingly, the external device 190 or the adaptor 150 may update the software of the breathing apparatus 100 to update the one or more operational parameters of the breathing apparatus 100, such as blower speed.

In some examples, the adaptor 150 may further include at least one of a microphone, an accelerometer, a temperature sensor and a relative humidity sensor. For example, the adaptor 150 may include the microphone to detect device specific frequencies associated with audible events of the breathing apparatus 100. Such audible events may occur when the air flow rate falls below a designated level or low power levels are detected on the battery pack 130. In some examples, the audible events may be associated with fan/blower damage, battery pack faults, etc. The breathing apparatus 100 may trigger an audible alarm when such events are detected, and consequently, picked up by the microphone. In some examples, the accelerometer may be utilized to determine accidental events, vibratory events, and environmental impacts associated with the breathing apparatus 100 (e.g., fall detection). Such data may be useful for compliance and insurance purposes. In some examples, the microphone and/or the accelerometer may communicate sensed data to the processor 172 and the processor 172 may store the data on the memory 170. Further, the data may be transmitted to the external device 190 through the at least one communication interface 164. In some examples, the microphone and/or the accelerometer may be disposed on the blower unit 110 and/or the battery pack 130.

In some examples, the temperature sensor may detect the temperature of the components of the breathing apparatus 100. In some examples, the relative humidity sensor may determine the relative humidity surrounding the breathing apparatus. In some examples, the adaptor 150 may further include one or more sensors (not shown) to detect one or more device specific parameters of the breathing apparatus 100. For example, the one or more sensors may detect ambient temperature, ambient pressure, flow rate, pressure drop across filter, headtop pressure, rate of breathing of a user, parameters related to the electric motor (such as, motor current and motor speed), fan speed, adverse environmental conditions, physiological parameters of a user, a missing filter, an incorrect filter, or whether the filter has been changed, or removed, or replaced, or the like. The one or more sensors may be coupled to the processor 172 through the at least one communication interface 164. Further, the processor 172 may be configured to store data associated with one or more device specific parameters on the memory 170. In some examples, the sensors may be disposed on the blower unit 110 and/or the battery pack 130. In some examples, the data from the sensors described above may be stored on the memory 170 through the at least one communication interface 164 for future processing. For example, the memory 170 may store a current flowing through the at least one battery electrical terminal 136, a voltage at the at least one battery electrical terminal 136, a power usage of the breathing apparatus 100 over a time period, an On/Off status of the breathing apparatus 100, audible events associated with the breathing apparatus 100, accidental events, vibratory alarms, environmental impacts, adverse environmental conditions, faults occurred during operation of the breathing apparatus 100, software update history, one or more operational parameters associated with the breathing apparatus 100, etc.

In some examples, the processor 172 may determine a location of the breathing apparatus 100 by receiving data from the external device 190. Further, the processor 172 may modify the device specific parameters of the breathing apparatus 100 based on a region of operation of the breathing apparatus 100. Such an option may be helpful as regulations governing operation of the breathing apparatus 100 may vary with countries and regions. For example, some countries or regions may require flow rates to be greater than other regions.

In some examples, the at least one communication interface 164 may include a physical interface 166 for connecting with a cable coupled to the external device 190. By way of example only, the connector may be any proprietary or suitable industry standard electrical connector, such as standard Universal Serial Bus (USB) port, micro-USB, RS232, etc. The at least one communication interface 164 may transmit data to the external device 190 or receive data from the external device 190 via the physical interface 166. For example, a service technician may connect with the breathing apparatus 100 through the physical interface 166 and read data stored within the memory 170 or download firmware to the breathing apparatus 100.

In some examples, the adaptor 150 may further include power storage devices, such as electrochemical cells, for providing additional power to the breathing apparatus 100 based on application requirements. Such power storage devices may be separate from the battery pack 130. In some examples, the adaptor 150 may further include suitable mechanical connections for connecting additional filters/filter cartridges or flexible connection hoses.

In some examples, the adaptor 150 may further include a user interface 186 communicably coupled to the at least one communication interface 164. In some examples, the user interface 186 may include a display, lights, buttons, keys (such as arrow or other indicator keys), and may be able to provide alerts to the user in a variety of ways, such as by sounding an alarm or vibrating. In some examples, the user interface 186 may be configured to output one or more operational settings of the breathing apparatus 100. For example, the one or more operational settings may include a flow rate of the blower, On/Off status, current and voltage status, power usage over time, a filter clogging status, battery pack charge status, revision level of blower unit processor, wired and wirelessly connected devices and associated communication signal strength, etc. Further, the user interface 186 may provide diagnostic information, such as fan/blower damage, battery pack faults, environmental impacts, adverse environmental conditions, etc.

In some examples, the user interface 186 may allow selection of the one or more operational settings of the breathing apparatus 100. For example, selection of the one or more operational settings may not be available when the breathing apparatus 100 is first manufactured. The adaptor 150 may allow such a functionality when connected. The user interface 186 may be used for a variety of functions. For example, the user interface 186 may be able to acknowledge or snooze an alert through the user interface 186. In some examples, the user interface 186 may further be configured to output troubleshooting and/or maintenance information for the breathing apparatus 100.

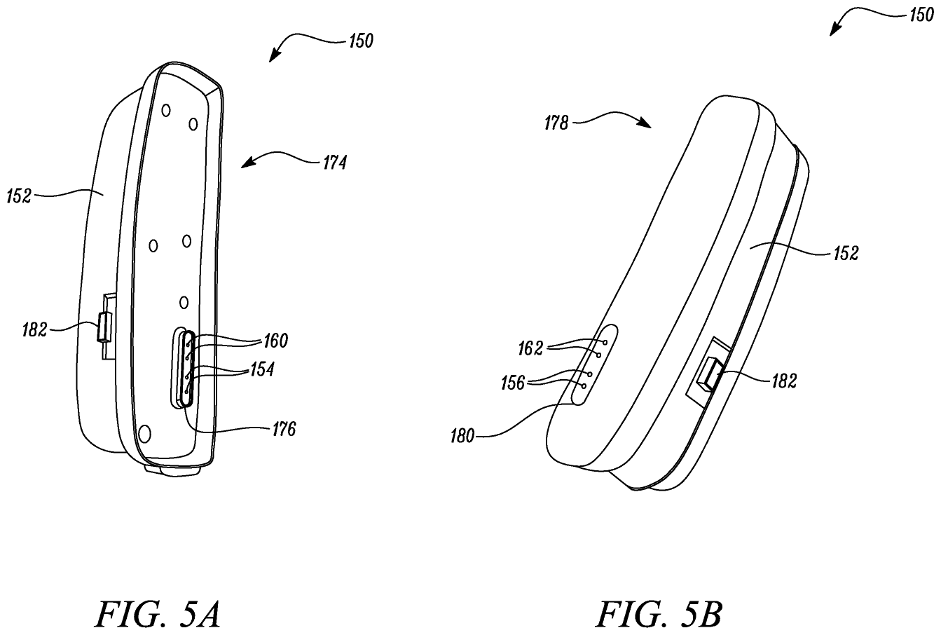

FIGS. 5A-5B illustrate perspective views of the adaptor 150 of the breathing apparatus 100. FIG. 5A illustrates a bottom portion 174 of the adaptor 150 including the adaptor housing 152. In the illustrated example, the adaptor 150 further includes a first connector 176 including the at least one first electrical contact 154 and the at least one first communication contact 160. Referring to FIGS. 4 and 5A, the first connector 176 may physically engage with the at least one battery electrical terminal 136 and the at least one battery communication terminal 138 of the battery pack 130. In some examples, the first connector 176 may be configured as a male connector. However, in other examples, the first connector 176 may alternatively be configured as a female connector. In the example shown in FIG. 5A, the first connector 176 includes a pair of first electrical contacts 154 and a pair of one first communication contacts 160. However, the first connector 176 may include any number of the first electrical contacts 154 and the first communication contacts 160 based on application requirements.

FIG. 5B illustrates a top portion 178 of the adaptor 150. The adaptor 150 further includes a second connector 180 including the at least one second electrical contact 156 and the at least one second communication contact 162. Referring to FIGS. 4 and 5B, the second connector 180 may physically engage with the at least one blower electrical terminal 118 and the at least one blower communication terminal 120 of the blower unit 110. In the example shown in FIG. 5B, the second connector 180 is configured as a female connector, however, the second connector 180 may alternatively be configured as a male connector. It is to be understood that the first connector 176 and the second connector 180 shown in FIGS. 5A and 5B, respectively, are exemplary in nature, and various alternatives are within the scope of the present disclosure. In some examples, the physical interface 166 (shown in FIG. 4) may include a connector 182 as shown in FIGS. 5A and 5B.

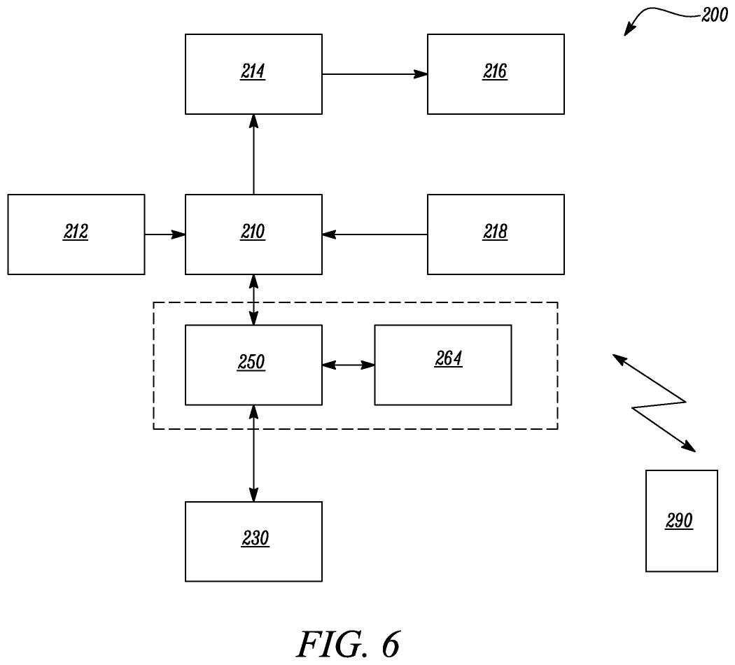

FIG. 6 illustrates a schematic block diagram of an example of a breathing apparatus 200. In some examples, the breathing apparatus 200 may be similar to the breathing apparatus 10 of FIG. 1 or the breathing apparatus 100 of FIGS. 2-3. The breathing apparatus 200 includes a blower unit 210 and a battery pack 230. The blower unit 210 may include a blower (not shown). In some examples, the blower of the blower unit 210 may include a housing in which a fan wheel is arranged for producing a forced air flow. In some examples, a filter 212 may be arranged upstream or downstream of the fan wheel to purify ambient air suctioned by the fan wheel.

In some examples, the blower unit 210 may be connected to a headtop 214 through a flexible connection hose, for example, the flexible connection hose 18 of FIG. 1. In some examples, the headtop 214 may be worn on a head of a user (e.g., the user 12 of FIG. 1). Further, the headtop 214 may partially enclose the head of the user to form a breathing zone 216 around at least an orinasal area of a face of the user. In some examples, the headtop 214 may be a helmet, a mask, or a full suit, provided it covers the orinasal area of the face of the user, to direct air to the breathing zone 216. In some examples, full face respirators or half face mask respirators may be used as headtop 214 in conjunction with the examples of the present disclosure.

The blower unit 210 may draw air through the blower and supply purified air to the headtop 214 and the breathing zone 216. In some examples, the filter 212 may be configured to remove particles, gases, vapors, etc., from the ambient air before the air is delivered to the headtop 214. The filtered air may be delivered from the blower unit 210 to the breathing zone 216 through the flexible connection hose. In some examples, the blower unit 210 may be arranged on a harness 218 in the form of a belt, such that the user may carry the blower unit 210 in any working environment. It should be understood that the breathing apparatus 200 as illustrated in FIG. 6 is shown by way of example only, and the type and configuration of the breathing apparatus 200 may differ based on application requirements. For example, the breathing apparatus 200 may not include the flexible connection hose in certain instances, such as, for example, where the breathing apparatus 200 is a head or face mounted powered air purifying respirator (PAPR).

The breathing apparatus 200 further includes an adaptor 250 physically connected to the blower unit 210 and the battery pack 230. The adaptor 250 includes at least one communication interface 264 communicably coupled to the blower unit 210 and the battery pack 230. The at least one communication interface 264 may receive data from at least one of the blower unit 210 and the battery pack 230 and may transmit the data to an external device 290.

In some examples, the adaptor 250 may be used with a breathing apparatus that lack inherent capability to communicate data, such as configuration settings and device specific parameters, outside the breathing apparatus. In such examples, the adaptor 250 may allow data to be transmitted to the external device 290, such as a portable user interface device, a computer or a server, through the at least one communication interface 264.

In some examples, the at least one communication interface 264 may transmit data to the external device 290 during storage or non-operational period of the breathing apparatus 200.

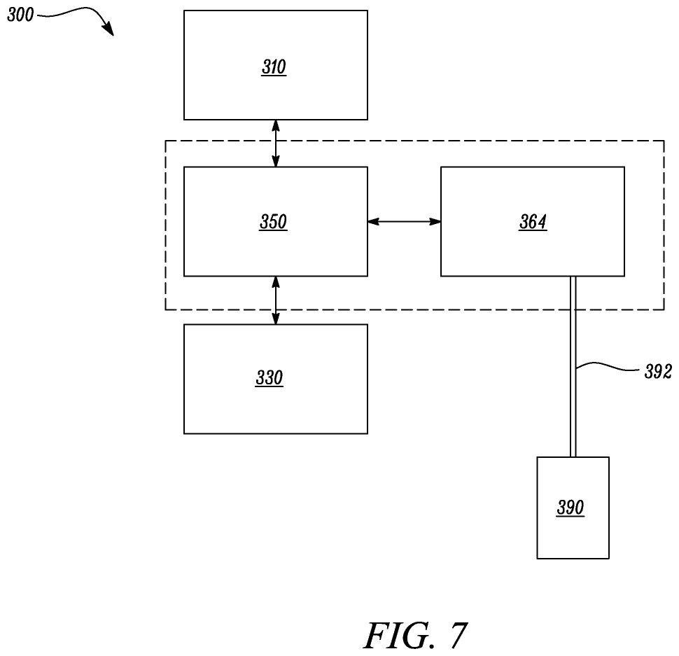

FIG. 7 illustrates a schematic block diagram of an example of a breathing apparatus 300 during data transfer. The breathing apparatus 300 may be similar to the breathing apparatus 100 of FIGS. 2-3 or the breathing apparatus 200 of FIG. 6. The breathing apparatus 300 includes an adaptor 350 physically connected to a blower unit 310 and a battery pack 330. The adaptor 350 includes at least one communication interface 364 for receiving data from at least one of the blower unit 310 and the battery pack 330, and transmitting data to an external device 390. For example, the at least one communication interface 364 may transmit data and device specific parameters associated with the breathing apparatus 300, such as a power status of the battery pack 330, a shelf life of the battery pack 330, a unique identification associated with the breathing apparatus 300, and operational history of the breathing apparatus 300 including runtime and configuration settings, filter clogging, etc. In some examples, the data may be transmitted periodically after a predetermined period of time. This may save useful power of the battery pack 330.

In the illustrated example, a cable 392 physically connects the at least one communication interface 364 with the external device 390. The cable 392 may be removably connected to the at least one communication interface 364 and the external device 390. The cable 392 may allow data transfer between the at least one communication interface 364 and the external device 390. However, in an alternative example, the at least one communication interface 364 may be wirelessly connected to the external device 390.

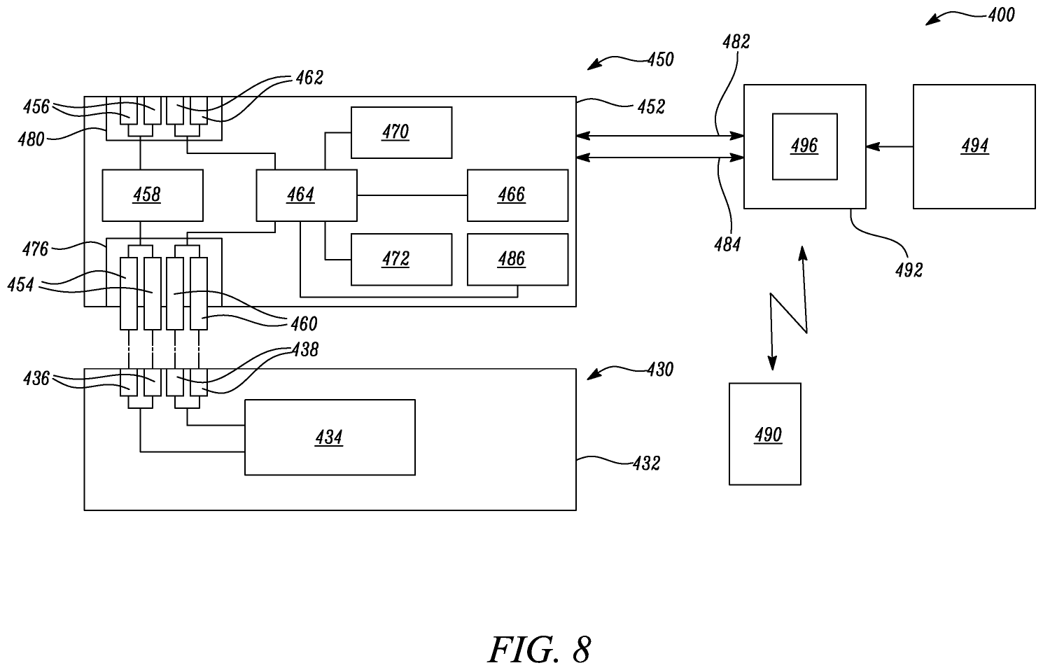

FIG. 8. illustrates a schematic block diagram of a charging system 400. In some examples, the charging system 400 may include one or more components of the breathing apparatus 100 of FIGS. 2-3, and the breathing apparatus 200, 300 of FIGS. 6 and 7. The charging system 400 includes a battery pack 430 including at least one electrochemical cell 434. The battery pack 430 may further include a pack housing 432. The at least one electrochemical cell 434 may be disposed in the pack housing 432. The battery pack 430 further includes at least one battery electrical terminal 436 electrically connected to the at least one electrochemical cell 434 and at least one battery communication terminal 438 communicably coupled to the at least one electrochemical cell 434.

The charging system 400 system further includes an adaptor 450 including an adaptor housing 452 physically connected to the battery pack 430. In some examples, the adaptor housing 452 may be mechanically connected to the battery pack 430. The adaptor 450 further includes at least one first electrical contact 454 disposed on the adaptor housing 452 and electrically connected with the at least one battery electrical terminal 436 of the battery pack 430. The adaptor 450 may further include at least one second electrical contact 456 disposed on the adaptor housing 452 and configured to be electrically connected with at least one blower electrical terminal (not shown) of a blower unit (not shown). For example, the adaptor 450 may be connected to the blower unit 110 of FIG. 4. The adaptor 450 further includes at least one electrical connection 458 disposed in the adaptor housing 452 and electrically coupled to the at least one first electrical contact 454. Specifically, the at least one electrical connection 458 may electrically connect the at least one first electrical contact 454 and the at least one second electrical contact 456. In some examples, the at least one electrical connection 458 may include one or more conductors that facilitate transfer of electrical power. Further, the at least one electrical connection 458 may include one or more printed circuit boards (PCB) having electrically conductive traces formed on one or more surfaces to facilitate transfer of electrical power.

The adaptor 450 may further include at least one first communication contact 460 disposed on the adaptor housing 452 and engaged with the at least one battery communication terminal 438. The adaptor 450 may further include at least one second communication contact 462 disposed on the adaptor housing 452 and configured to engage with at least one blower communication terminal (not shown) of the blower unit. The adaptor 450 further includes at least one communication interface 464 associated with the adaptor housing 452 and communicably coupled to the at least one battery communication terminal 438. The at least one communication interface 464 is configured to exchange data with the battery pack 330. Specifically, the at least one communication interface 464 may be communicably coupled to the at least one first communication contact 460 and the at least one second communication contact 462.

In some examples, the data communication may occur between the at least one communication interface 464 and the at least one battery communication terminal 438 through direct electrical/physical contact. In some examples, the at least one communication interface 464 may be wirelessly coupled to the at least one battery communication terminal 438.

The charging system 400 system further includes a charger 492 communicably coupled to the at least one electrical connection 458 of the adaptor 450. In some examples, the charging system 400 further includes a cable 482 physically connecting the charger 492 to the adaptor 450. The charger 492 may include a power source (e.g., batteries) for charging the at least one electrochemical cell 434 of the battery pack 430. A charging current may be provided to the at least one electrochemical cell 434 through the cable 482, the at least one electrical connection 458, the at least one first electrical contact 454 and the at least one battery electrical terminal 436.

Alternatively, in some examples, the charger 492 may charge the at least one electrochemical cell 434 of the battery pack 430 through inductive charging (e.g., using wireless charging standard such as Qi). In such examples, the cable 482 may be replaced by wireless transmission of electromagnetic energy. For example, the charger 492 may include a transmitting coil (not shown) and the at least one electrical connection 458 may include a receiving coil (not shown). The charger 492 may transmit the electromagnetic energy through the transmitting coil that induces a current in the receiving coil, thereby, charging the at least one electrochemical cell 434.

In some examples, the charger 492 may be electrically connected to an external power source 494 for charging the at least one electrochemical cell 434 of the battery pack 430, as illustrated in FIG. 8. In some examples, the external power source 494 may be a direct current (DC) power source, an alternating current (AC) power source or an alternative energy source (e.g., solar, wind, etc.) that may provide DC or AC power to the charger 492. Further, the charger 492 may be configured to charge the at least one electrochemical cell 434 using the external power source 494 through the cable 482 or through inductive charging.

The charger 492 includes at least one charger interface 496 communicably coupled to the at least one communication interface 464 of the adaptor 450. In some examples, the at least one charger interface 496 may be coupled to the at least one communication interface 464 through a communication link 484. For instance, the communication link 484 may be a physical or a virtual communication channel between the at least one charger interface 496 and the at least one communication interface 464. In some examples, the communication link 484 may represent several wired and/or wireless links. In some examples, the communication link 484 may represent one or more networks and/or direct connections. In some examples, the communication link 484 and the cable 482 may be realized as a single line or a cable. The at least one charger interface 496 is configured to transmit data between the at least one communication interface 464 and an external device 490.

In some examples, the external device 490 may be a computer system, a server, or a portable user interface device. In some examples, the computer system or the server may be in the form of a general-purpose computing device. In some examples, the portable user interface device may be configured to execute an application (or app) that is tailored to providing an easy setup and/or easy to use interface for interaction with the charging system 400. In some cases, the external device 490 may be a smartphone or other mobile terminal, a laptop, or any other portable computing/communication device. As such, the portable user interface device may include processing circuitry that is enabled to interface with the at least one charger interface 496 to program, control or otherwise interact with the charging system 400. For example, the external device 490 may change device specific settings related to the charging system 400.

In some examples the adaptor 450 may further include a first connector 476 including the at least one first electrical contact 454 and the at least one first communication contact 460. In some examples, the first connector 476 may physically engage with the at least one battery electrical terminal 436 and the at least one battery communication terminal 438.

In some examples the adaptor 450 further includes a second connector 480 including the at least one second electrical contact 456 and the at least one second communication contact 462. In some examples, the second connector 480 may be configured to physically engage with the at least one blower electrical terminal (not shown) and the at least one blower communication terminal (not shown).

In some examples, the adaptor 450 further includes a memory 470 disposed within the adaptor housing 452 and communicably coupled to the at least one communication interface 464. In some examples, the memory 470 may be configured to store data received from the at least one communication interface 464. For example, data related to device operation, device specific parameters, and identification may be stored within the memory 470. In some examples, the at least one charger interface 496 of the charger 492 may receive data stored in the memory 470 via the at least one communication interface 464 of the adaptor 450. Further, the data may be transmitted by the at least one charger interface 496 of the charger 492 to the external device 490 through the at least one communication interface 464 of the adaptor 450.

In some examples, the adaptor 450 may further include a processor 472 disposed within the adaptor housing 452 and communicably coupled to the at least one communication interface 464. The processor 472 may be configured to process data received from the at least one communication interface 464. In some examples, the processor 472 or the external device 490 may be configured to process data and device specific parameters of the breathing apparatus 100, 200, 300 as described above with reference to FIGS. 2-7.

In some examples, the data may be related to the operation of the charging system 400. For example, the data may be related to date of last activation or usage, time period of operation, number of charging cycles, charging characteristics, such as charging current, voltage, temperature, etc., present charge status of the at least one electrochemical cell 434, remaining life of the at least one electrochemical cell 434, rate of discharging, charger failure, charger diagnostic or troubleshooting information, and/or the like. In some example, the data may be associated with the charger 492. For example, the data may be associated with the count of charging cycles, charging time, charging voltage/current over time, etc.

In some examples, the data may be related to the breathing apparatus 100, 200, 300. For examples, the data may be associated with device configuration, unique identification designation (UID) of the breathing apparatus 100, 200, 300, a filter, or a headtop. In some examples, the data may be associated with device specific parameters (e.g., flow rate, volumetric flow, filter clogging), usage details including date and time, total operational time of a blower unit or a corresponding type of filter, remaining useful life of components, alarm events associated with the breathing apparatus 100, 200, 300, such as low flow rate or low battery power, electric motor control parameters, such as speed, current, voltage, and/or the like.

In some examples, the adaptor 450 or the processor 472 may control one or more operational settings of the charging system 400. For example, the adaptor 450 may control or regulate (start/stop) charging power to the battery pack 430. Further, the adaptor 450 may enable or disable charging power to the battery pack 430. For example, the adaptor 450 may stop charging power to the battery pack 430 in case of any technical issue with the battery pack 430, such as short circuit, electrochemical cell damage, etc. In some examples, the adaptor 450 may restrict power to the battery pack 430 during maintenance, repair or troubleshooting.

In some examples, the adaptor 450 may further include a user interface 486 communicably coupled to the at least one communication interface 464. In some examples, the user interface 486 may include a display, lights, buttons, keys (such as arrow or other indicator keys), and may be able to provide alerts to the user in a variety of ways, such as by sounding an alarm or vibrating. In some examples, the user interface 486 may be configured to output one or more operational settings of the charging system 400. For example, the one or more operational settings may include charging time, charging status (e.g. On/Off, start, stop, etc.), charge count, charging voltage, charging current, battery pack charge status, wired or wirelessly connected devices and their corresponding signal strength, etc. Further, the user interface 186 may provide audible events, diagnostic information such as fan/blower damage, battery pack faults, environmental impacts, adverse environmental conditions, etc.

In some examples, the user interface 486 may allow selection of the one or more operational settings of the charging system 400. For example, the one or more operational settings may include charger On/Off, charging time period, charging schedules, etc. The user interface 486 may be used for a variety of functions. For example, the user interface 486 may be able to acknowledge or snooze an alert through the user interface 486. In some examples, the user interface 486 may further be configured to output troubleshooting and/or maintenance information for the charging system 400.

In some examples, the data may be transmitted between the at least one charger interface 496 and the external device 490 wirelessly or through a physical interface 466. In some examples, the physical interface 466 may allow direct connection to the external device 490 using a cable. In some examples, the data and device specific parameters of the charging system 400 may be transmitted automatically to the external device 490. In some examples, the data and device specific parameters may be transmitted periodically to the external device 490. In some examples, data transmission may occur intermittently or continuously over a period of time.

In some examples, the at least one charger interface 496 may include a wireless interface for data communication via one or more wireless communication protocols. In some examples, the one or more wireless communication protocols may include, but not limited to, Bluetooth®, infrared, Wi-Fi, Zigbee, wireless universal serial bus (USB), radio frequency, near-field communication (NFC), RFID protocols, or generally any wireless communication protocol. In some examples, data may be transmitted through a communication network. In some examples, the communication network may include one or more of a wireless network, a wired network, a local area network (LAN), a metropolitan area network (MAN), a wide area network (WAN), a wireless personal area network (WPAN), 802.11, 802.16, 802.20, WiMax networks, a direct connection, such as through a Universal Serial Bus (USB) port, and the like, and may include a set of interconnected networks that make up the Internet. In some examples, the wireless network may include, such as, but not restricted to, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc.

Examples of the communication network may further include, but are not limited to, a personal area network (PAN), a storage area network (SAN), a home area network (HAN), a campus area network (CAN), an enterprise private network (EPN), Internet, a global area network (GAN), and so forth. Examples are intended to include or otherwise cover any type of network, including known, related art, and/or later developed technologies to connect the at least one charger interface 496 and the external device 490.

In some examples, the at least one charger interface 496 of the charger 492 receives data from the external device 490 and stores the data in the memory 470 via the at least one communication interface 464 of the adaptor 450. For example, data and parameters related to the charging system 400, especially software updates, may be transmitted by the external device 490. Furthermore, the external device 490 may be used to determine whether the parameters associated with the charging system 400, especially the program software, are up to date. Additionally, the external device 490 may allow reconfiguration and modification of device specific parameters and settings of the charging system 400 through the external device 490.

Such a configuration of the charging system 400 may be helpful for a breathing apparatus that may not include any provision for communication with the external device 490. In such examples, the charger 492 may facilitate data stored within the memory 470 to be transmitted to the external device 490 through the at least one charger interface 496.

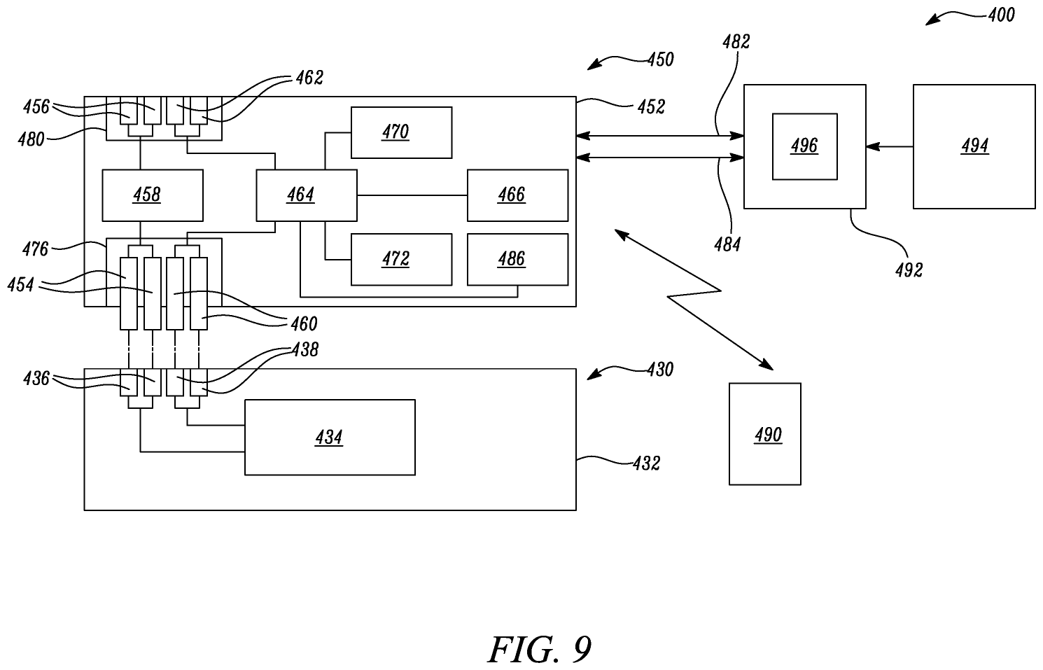

In some embodiments, the adaptor 450 may transmit data directly between the at least one communication interface 464 and the external device 490, as illustrated in the example shown in FIG. 9. FIG. 9 illustrates a schematic block diagram showing the charging system 400 of FIG. 8 wherein the data is directly transmitted between the adaptor 450 and the external device 490. In some examples, the at least one communication interface 464 may include a wireless interface for exchanging data with the external device 490. In some examples, data may be transmitted through wired (for example, the physical interface 466) communication interface. In some examples, such a transmission of data may occur during charging of the at least one electrochemical cell 434. This may reduce draining of the at least one electrochemical cell 434 during operation of the breathing apparatus 100, 200, 300.

Referring again to FIGS. 2-4, the breathing apparatus 100 includes the blower unit 110 including the unit housing 114 and the blower 116. The blower unit 110 further includes the at least one blower electrical terminal 118 disposed on the unit housing 114 and electrically connected to the blower 116. The blower unit 110 further includes the at least one blower communication terminal 120 disposed on the unit housing 114 and communicably coupled to the blower 116. The breathing apparatus 100 further includes the battery pack 130 for powering the blower unit 110. The battery pack 130 includes the pack housing 132 and the at least one electrochemical cell 134 disposed in the pack housing 132. The battery pack 130 further includes the at least one battery electrical terminal 136 disposed on the pack housing 132 and electrically connected to the at least one electrochemical cell 134. The battery pack 130 further includes the at least one battery communication terminal 138 disposed on the pack housing 132 and communicably coupled to the at least one electrochemical cell 134.

The breathing apparatus 100 further includes the adaptor 150 including the adaptor housing 152 physically and detachably connected to the unit housing 114 and the pack housing 132. The adaptor 150 further includes the at least one first electrical contact 154 disposed on the adaptor housing 152 and electrically connected with the at least one battery electrical terminal 136 of the battery pack 130. The adaptor 150 further includes the at least one second electrical contact 156 disposed on the adaptor housing 152 and electrically connected with the at least one blower electrical terminal 118 of the blower unit 110. The adaptor 150 further includes the at least one electrical connection 158 disposed in the adaptor housing 152 and electrically connecting the at least one first electrical contact 154 and the at least one second electrical contact 156, such that the blower 116 is electrically coupled to the at least one electrochemical cell 134.

The adaptor 150 further includes the at least one first communication contact 160 disposed on the adaptor housing 152 and engaged with the at least one battery communication terminal 138. The adaptor 150 further includes the at least one second communication contact 162 disposed on the adaptor housing 152 and engaged with the at least one blower communication terminal 120. The adaptor 150 further includes the at least one communication interface 164 associated with the adaptor housing 152 and communicably coupled to the at least one first communication contact 160 and the at least one second communication contact 162. The at least one communication interface 164 is configured to allow exchange of data between the external device 190 and at least one of the blower unit 110 and the battery pack 130.

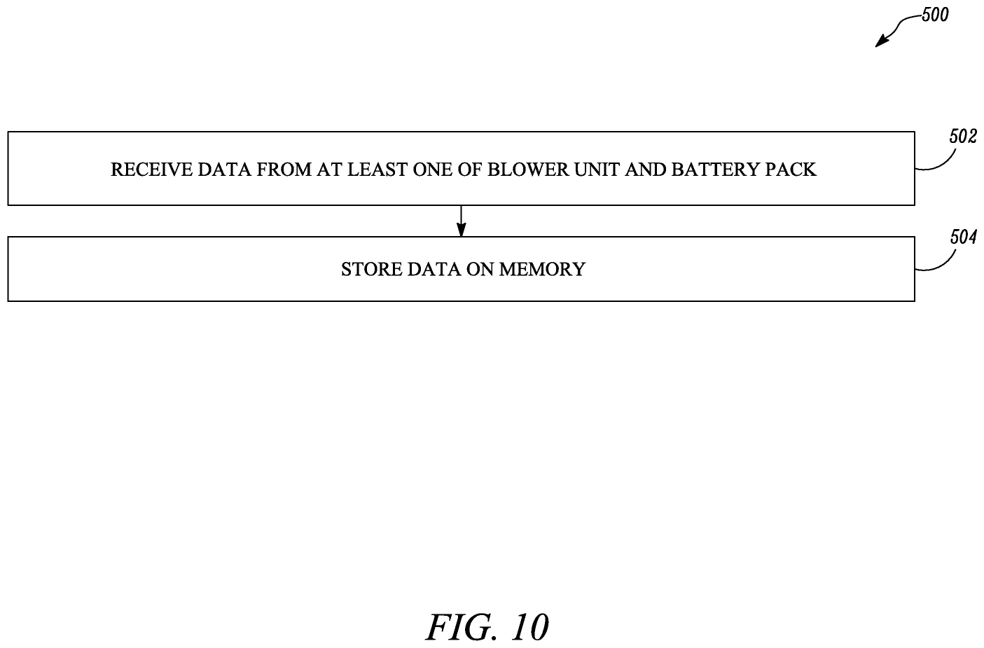

FIG. 10 is a flow chart illustrating a method 500 for use with the breathing apparatus 100 of FIG. 4. At step 502, the method 500 includes receiving, via the at least one communication interface 164, data from at least one of the blower unit 110 and the battery pack 130. The data may be associated with the operation of the blower unit 110 and/or the battery pack 130. For example, the data may be associated with at least one of a current flowing through the at least one battery electrical terminal 136, a voltage at the at least one battery electrical terminal 136, an On/Off status of the breathing apparatus 100, a power usage of the breathing apparatus 100 over a time period, one or more audible events detected by the microphone of the adaptor 150, one or more vibratory alarms and environmental impacts detected by the accelerometer of the breathing apparatus 100, and one or more adverse environmental conditions. In some examples, the microphone and/or the accelerometer may be disposed on the blower unit 110 and/or the battery pack 130. At step 504, the method 500 further includes storing the data on the memory 170 communicably coupled to the at least one communication interface 164. In some examples, the memory 170 may be disposed within the adaptor housing 152 of the adaptor 150.

Those skilled in the art will appreciate that the adaptor may be retrofitted with the existing breathing apparatus comprising the blower unit and the battery pack to enable data transfer to and from the blower unit and/or the battery pack. Further, the adaptor may new enable functions on the breathing apparatus. For example, the adaptor may allow data communication with an external device. The existing users of the breathing apparatus may not necessarily require purchase of a new product when the intended functions may be available by retrofitting the existing breathing apparatus with the adaptor of the present disclosure. Thus, the adaptor of the present disclosure may save cost of purchasing a new product that provides such functions. The flexibility of communication with the adaptor may allow new updates to be added to the existing breathing apparatus. In some cases, the adaptor may allow repair of the breathing apparatus on field based on the functions provided by the adaptor without the need to replace the blower unit and/or the battery pack.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including, but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A breathing apparatus comprising:
a blower unit comprising a blower, at least one blower electrical terminal electrically connected to the blower and at least one blower communication terminal communicably coupled to the blower;
a battery pack comprising at least one electrochemical cell, at least one battery electrical terminal electrically connected to the electrochemical cell and at least one battery communication terminal communicably coupled to the at least one electrochemical cell; and
an adaptor comprising:
an adaptor housing mechanically connected to the blower unit and the battery pack;
at least one first electrical contact disposed on the adaptor housing and electrically connected with the at least one battery electrical terminal of the battery pack;
at least one second electrical contact disposed on the adaptor housing and electrically connected with the at least one blower electrical terminal of the blower unit;
at least one electrical connection disposed in the adaptor housing and electrically connecting the at least one first electrical contact and the at least one second electrical contact, such that the blower is electrically coupled to the at least one electrochemical cell; and
at least one communication interface associated with the adaptor housing and communicably coupled to the at least one blower communication terminal and the at least one battery communication terminal, the at least one communication interface configured to exchange data with an external device.

2. The breathing apparatus of claim 1, wherein the adaptor further comprises:
at least one first communication contact disposed on the adaptor housing and engaged with the at least one battery communication terminal; and
at least one second communication contact disposed on the adaptor housing and engaged with the at least one blower communication terminal;
wherein the at least one communication interface is communicably coupled to the at least one first communication contact and the at least one second communication contact.

3. The breathing apparatus of claim 1, wherein the at least one communication interface is wirelessly coupled to the at least one battery communication terminal and the at least one blower communication terminal.

4. The breathing apparatus of claim 1, wherein the adaptor further comprises a memory disposed within the adaptor housing and communicably coupled to the at least one communication interface, the memory configured to store data received from the at least one communication interface.

5. The breathing apparatus of claim 1, wherein the at least one communication interface comprises a wireless interface for transmitting data to the external device.

6. (canceled)

7. The breathing apparatus of claim 1, wherein the adaptor further comprises a processor disposed within the adaptor housing and communicably coupled to the at least one communication interface, the processor configured to exchange data with the at least one communication interface.

8-17. (canceled)

18. The breathing apparatus of claim 1, wherein the adaptor further comprises a first connector comprising the at least one first electrical contact and at least one first communication contact, the first connector physically engaging with the at least one battery electrical terminal and the at least one battery communication terminal.

19. The breathing apparatus of claim 1, wherein the adaptor further comprises a second connector comprising the at least one second electrical contact and at least one second communication contact, the second connector physically engaging with the at least one blower electrical terminal and the at least one blower communication terminal.

20. (canceled)

21. The breathing apparatus of claim 1, wherein the adaptor further comprises a user interface communicably coupled to the at least one communication interface, the user interface configured to output one or more operational settings of the breathing apparatus.

22-24. (canceled)

25. A method for use with the breathing apparatus of claim 1, the method comprising:
receiving, via the at least one communication interface, data from at least one of the blower unit and the battery pack, and
storing the data on a memory communicably coupled to the at least one communication interface, wherein the memory is disposed within the adaptor housing of the adaptor.

26. (canceled)

27. A charging system comprising:
a battery pack comprising at least one electrochemical cell, at least one battery electrical terminal electrically connected to the at least one electrochemical cell and at least one battery communication terminal communicably coupled to the at least one electrochemical cell; and
an adaptor comprising:
an adaptor housing mechanically connected to the battery pack;
at least one first electrical contact disposed on the adaptor housing and electrically connected with the at least one battery electrical terminal of the battery pack;
at least one electrical connection disposed in the adaptor housing and electrically coupled to the at least one first electrical contact; and
at least one communication interface associated with the adaptor housing and communicably coupled to the at least one battery communication terminal, the at least one communication interface configured to exchange data with the battery pack; and
a charger communicably coupled to the at least one electrical connection of the adaptor, the charger comprising at least one charger interface communicably coupled to the at least one communication interface of the adaptor, wherein the at least one charger interface is configured to transmit data between the at least one communication interface and an external device.

28. The charging system of claim 27, wherein the adaptor further comprises at least one second electrical contact disposed on the adaptor housing and configured to be electrically connected with at least one blower electrical terminal of a blower unit, and wherein the at least one electrical connection electrically connects the at least one first electrical contact and the at least one second electrical contact.

29. The charging system of claim 27, wherein the adaptor further comprises:
at least one first communication contact disposed on the adaptor housing and engaged with the at least one battery communication terminal; and
at least one second communication contact disposed on the adaptor housing and configured to engage with at least one blower communication terminal of a blower unit;
wherein the at least one communication interface is communicably coupled to the at least one first communication contact and the at least one second communication contact.

30. The charging system of claim 27, wherein the at least one communication interface is wirelessly coupled to the at least one battery communication terminal.

31. The charging system of claim 27, wherein the at least one communication interface comprises a wireless interface for exchanging data with the external device.

32. The charging system of claim 27, wherein the adaptor further comprises a memory disposed within the adaptor housing and communicably coupled to the at least one communication interface, the memory configured to store data received from the at least one communication interface.

33-35. (canceled)

36. The charging system of claim 27, wherein the adaptor further comprises a first connector comprising the at least one first electrical contact and at least one first communication contact, the first connector physically engaging with the at least one battery electrical terminal and the at least one battery communication terminal.

37. The charging system of claim 27, wherein the adaptor further comprises a second connector comprising at least one second electrical contact and at least one second communication contact, the second connector is configured to physically engage with at least one blower electrical terminal and at least one blower communication terminal of a blower unit.

38. (canceled)

39. The charging system of claim 27, wherein the adaptor further comprises a user interface communicably coupled to the at least one communication interface, the user interface configured to output one or more operational settings of the charging system.

40. (canceled)

41. A breathing apparatus comprising:
a blower unit comprising a unit housing, a blower, at least one blower electrical terminal disposed on the unit housing and electrically connected to the blower, and at least one blower communication terminal disposed on the unit housing and communicably coupled to the blower;
a battery pack for powering the blower unit, the battery pack comprising a pack housing, at least one electrochemical cell disposed in the pack housing, at least one battery electrical terminal disposed on the pack housing and electrically connected to the at least one electrochemical cell, and at least one battery communication terminal disposed on the pack housing and communicably coupled to the at least one electrochemical cell; and
an adaptor comprising:
an adaptor housing physically and detachably connected to the unit housing and the pack housing;
at least one first electrical contact disposed on the adaptor housing and electrically connected with the at least one battery electrical terminal of the battery pack;
at least one second electrical contact disposed on the adaptor housing and electrically connected with the at least one blower electrical terminal of the blower unit;
at least one electrical connection disposed in the adaptor housing and electrically connecting the at least one first electrical contact and the at least one second electrical contact, such that the blower is electrically coupled to the at least one electrochemical cell;
at least one first communication contact disposed on the adaptor housing and engaged with the at least one battery communication terminal;
at least one second communication contact disposed on the adaptor housing and engaged with the at least one blower communication terminal; and
at least one communication interface associated with the adaptor housing and communicably coupled to the at least one first communication contact and the at least one second communication contact, wherein the at least one communication interface is configured to allow exchange of data between an external device and at least one of the blower unit and the battery pack.
